(19) United States
(12) Patent Application Publication
(10) Pub. No.: US 2023/0334660 A1
(43) Pub. Date: Oct. 19, 2023

(54) DIGITAL TISSUE SEGMENTATION AND VIEWING

(71) Applicant: Steven Frank, Framingham, MA (US)

(72) Inventor: Steven Frank, Framingham, MA (US)

(21) Appl. No.: 18/122,390

(22) Filed: Mar. 16, 2023

Related U.S. Application Data
(60) Provisional application No. 63/331,265, filed on Apr. 15, 2022.
(60) Provisional application No. 63/431,341, filed on Dec. 9, 2022.

(51) Int. Cl. G06T 7/00; G06T 7/11

(52) U.S. Cl. CPC G06T 7/0012; G06T 7/11

(57) ABSTRACT

Methods and systems for representing a tissue segmentation from a source digital image computationally generate, from a source digital image of an anatomic region, a digital tissue segmentation visually indicating regions of interest corresponding to an abnormal condition associated with at least portions of the anatomic region. The source image and the tissue segmentation may be alternately displayed in registration on a mobile device at a gesturally selected magnification level.

### CROSS-REFERENCE TO RELATED APPLICATION

This application claims priority to and the benefit of, and incorporates herein by reference in their entireties, U.S. Provisional Patent Application Nos. 63/331,265 (filed on Apr. 15, 2022) and 63/431,341 (filed on Dec. 9, 2022).

### FIELD OF THE INVENTION

The present invention relates, generally, to processing and automated classification of large, high-resolution digital images, and in particular to visually representing classification results corresponding to different tissue types at a subimage level.

### BACKGROUND

“Deep learning” approaches have been applied to a wide range of medical images with the objective of improving diagnostic accuracy and clinical practice. Many efforts have focused on images that are inherently small enough to be processed by convolutional neural networks (CNNs), or which can be downsampled to a suitable size without loss of fine features necessary to the classification task. In general, CNNs perform best at image sizes below 600×600 pixels; larger images entail complex architectures that are difficult to train, perform slowly, and require significant memory resources. Among the most challenging medical images to analyze computationally are digital whole-slide histopathology images, which are often quite large—10,000 to more than 100,000 pixels in each dimension. Their large size means that even traditional visual inspection by trained clinicians is difficult. To make such images amenable to CNN analysis, researchers have decomposed them into much smaller tiles that are processed individually. A probability framework may be applied to the tile-level classifications to classify the slide (see, e.g., U.S. Pat. No. 10,832,406). The most successful recent studies have achieved performance comparable to that of experienced specialists.

A longstanding impediment to clinical adoption of machine-learning techniques is the inability of many such techniques to convey the rationale behind a classification, diagnosis or other output. Black-box models whose reasoning is opaque or impervious to retrospective analysis may pose clinical dangers that outweigh the benefits of a computational approach. Until recently, CNNs have fallen squarely within the black-box category, but techniques such as gradient-based class saliency maps and gradient-weighted class activation maps (“Grad-CAM”) have pried the box open, highlighting the image regions important to a CNN classification.

More generally, the ability to visualize distinct tissue regions in a medical image can be important diagnostically whether or not an explicit classification is involved. Computational techniques for automatic “tissue segmentation” partition an image into segments corresponding to different tissue classes, e.g., whole organs or organ sub-regions (such as liver or lung segments, or muscle groups). Areas with pathologies such as tumors or inflammation can also be isolated using segmentation. Traditionally, diagnoses have been based on manual measurement of lesion dimensions and their number in a medical image. More recently, the role of imaging has grown beyond diagnosis to include quantitative characterization of tissue volume or shape, chemical composition, and functional activity; automated tissue segmentation has played an important part in this evolution. But segmentation techniques tend to be complex and computationally demanding, and may require knowledge of the imaged anatomical structure or other a priori information.

One consequence of this is the cumbersome manner in which segmentations are presented visually. Anatomic features corresponding to disease states or subtypes may be quite small, necessitating the ability to magnify to a high degree the regions of interest (ROIs) in an image; this, in turn, typically implies the need to buffer the entire image which, in the case of a histopathology slide, can be quite large. A ROI may be circled or otherwise identified in the image, and the user magnifies and inspects the region using a peripheral device such as a mouse or touchpad. Virtually all analytical tools involving ROI prediction involve some tradeoff between sensitivity (correctly identifying diseased regions) and precision or specificity (correctly excluding non-diseased tissue). For safety, medical image analysis typically emphasizes sensitivity in order to avoid missing disease. The price, of course, is visual “false alarms” that distract attention from the diseased tissue regions and reduce the usefulness of the analysis tool.

### SUMMARY

Embodiments of the present invention facilitate review of scaled-down images large enough to reveal anatomic features relevant to a condition under study but, often, much smaller than a source image. ROIs may be visually indicated, e.g., marked in colors corresponding to probability levels or bins associated with a disease condition, thereby enabling clinicians to focus attention progressively on different areas of the image to avoid fatigue and distraction (and mitigating the “false alarm” problem). For visual clarity, color may translucently overlie a grayscale version of the image. In some embodiments, the user may toggle between the source image and the colored ROI map. When deployed on a touchscreen device, the invention may enable users to gesturally control image magnification (e.g., using pinch and stretch gestures) and toggle between substantially identically magnified versions of the source image and the colored ROI map.

Embodiments of the invention may deployed on mobile devices. By “mobile device” is meant portable, typically hand-held electronic devices that can connect to the internet and typically include touchscreen capability. These include “smart phones” (such as the iPHONE sold by Apple Inc. and various phones running the ANDROID operating system supported by Google LLC) and tablet computers (e.g., the iPAD marketed by Apple Inc.). Laptop computers with touchscreens may be considered mobile devices. Common among them is the ability of users to gesturally manipulate displayed images, including altering the magnification thereof.

Embodiments of the invention can provide accurate tissue segmentations that do not require a priori knowledge of tissue type or other extrinsic information not found within the subject image. Moreover, the approaches discussed herein may be combined with classification analysis so that diseased tissue is not only delineated within an image but also characterized in terms of disease type. The techniques may be applied even to very large medical images such as digital pathology slides. In various embodiments, a source image is decomposed into smaller overlapping subimages such as square or rectangular tiles, which are silted based on a visual criterion. The visual criterion may be one or more of image entropy, density, background percentage, or other discriminator. A CNN produces tile-level classifications that are aggregated to produce a tissue segmentation and, in some embodiments, to classify the source image or a subregion thereof.

Overlapping subimages represents a useful data-augmentation expedient for training purposes, but also is found to enhance classification of test images and mapping accuracy, with the enhancement depending directly on the degree of overlap. In particular, the greater the degree of overlap, the greater will be the number of images that may contribute to the classification of any particular pixel, thereby potentially increasing the accuracy of the tissue segmentation.

In some implementations, a mobile device is configured to represent a tissue segmentation from a source digital image. The mobile device may comprise a processor; a computer memory including a first memory partition image buffer for storing a source digital image of an anatomic region (e.g., an in vivo region in an X-ray or mammogram or an in vitro tissue sample such as a biopsy) and a second memory partition for storing a tissue segmentation image digitally indicating probabilities of an abnormal condition associated with at least portions of the anatomic region (where the probabilities may, if desired, be indicated by at least two different colors); and a touchscreen in operative communication with the processor for (a) displaying a first one of the source digital image or the tissue segmentation image, (b) receiving a gestural command and, in response, changing the magnification of the displayed first image, and (c) in response to a toggle command, displaying the other image at a substantially identical magnification level and in registration with the first image (i.e., congruent in the same coordinate system). The processing of the source image and assembly of the tissue segmentation image may occur on the mobile device or remotely, at a server; in the latter case, the server may transmit the tissue segmentation image (or portion thereof) to the mobile device for local storage thereon along with the source image, facilitating the toggling operation.

The memory partition may be an image buffer or, in the case where rendering instructions rather than image data is stored, a register or location in volatile memory. If the tissue segmentation is an overlay on the source image, displaying the tissue segmentation can mean apply the overlay to the source image, and displaying the source image can correspond to removing the overlay therefrom. In some cases, the critical anatomy facilitating proper segmentation may be too small, and the analyzed image therefore too large, for practical transmission to and from (and viewing on) the mobile device. In such cases, the server may generate the segmentation based on one or more higher-resolution versions of the source image, but may transmit a scaled-down version of the tissue segmentation image (and a scaled-down version of the source image if one is not already stored locally) to the mobile device. In such cases, the resolution of the scaled-down image may be insufficient for clinical use, i.e., a medical practitioner may wish to view the critical anatomy at a higher resolution. In such cases, the server may store a mapping between the higher-resolution and scaled-down versions of the image. When the user of the mobile device enlarges the local, scaled-down image, coordinates specifying the displayed portion are sent—either upon user command or automatically by the mobile device—to the server, which fetches that portion of the source image or tissue segmentation image based on the stored mapping. The retrieved image portion at higher resolution is sent to the mobile device, which uses it to overwrite the currently displayed lower-resolution image portion.

Accordingly, in a first aspect, the invention relates to a method of computationally representing a tissue segmentation from a source digital image. In various embodiments, the method comprises the steps of computationally generating, from a source digital image of an anatomic region, a digital tissue segmentation visually indicating regions of interest corresponding to an abnormal condition associated with at least portions of the anatomic region; and alternately displaying the source image and the tissue segmentation in registration on a mobile device at a gesturally selected magnification level.

In various embodiments, the method further comprises representing the source digital image at a plurality of resolutions; relating the representations of the source image at the different resolutions via at least one geometric transformation; and responsive to an increase in magnification of a displayed image on the mobile device, replacing the displayed image with corresponding subject matter from a higher-resolution representation thereof.

The method may further comprises the steps of computationally generating the digital tissue segmentation from the source digital image at a selected one of the plurality of resolutions; applying the digital tissue segmentation to the source image at other resolutions; and responsive to an increase in magnification of a displayed digital tissue segmentation on the mobile device, replacing the displayed digital tissue segmentation with corresponding subject matter from a higher-resolution representation thereof.

In some embodiments, the source image is stored at multiple resolutions at a server in communication with the mobile device; the server may be configured to select the higher-resolution source image based on the increased magnification and to communicate a portion of the higher-resolution image to the mobile device for display thereon. The tissue segmentation may be generated remotely (e.g., at the server) and communicated to the mobile device for display, alternately with the source image, thereon. In other embodiments, the source image is stored at multiple resolutions on the mobile device, which is configured to replace the displayed image with a higher-resolution version of the displayed subject matter obtained from a higher-resolution source image.

In various embodiments, the digital tissue segmentation includes a plurality of color overlays or outlines each associated with a probability range for the abnormal condition and superimposed on corresponding regions of the digital image. The colors may, for example, be translucently superimposed over a grayscale version of the source image, or may instead surround the regions as outline borders (which may be colored). Each highlighted region may correspond to a union of overlapping subimage regions of the source image that have been individually analyzed and assigned classification probabilities by a neural network. Classification probabilities for overlapping subimage regions may be combined at a pixel level. The classification probabilities for pixels of the overlapping subimage regions may correspond to a maximum, a minimum or an average (which may be weighted or unweighted) of the probability values assigned to overlapping subimage region. Overlapping subimage regions may be obtained, for example, by selecting, from a candidate set of subimage regions, the subimage regions having image entropies between a pair of boundary entropy values

Alternatively or in addition, the digital tissue segmentation may include a plurality of overlays designating, and colorwise distinguishing, high-precision regions of interest and high-recall regions of interest superimposed on corresponding regions of the digital image. The method may, in some embodiments, include the step of computationally analyzing one or more regions of interest to identify a classification subtype associated therewith. In various embodiments, the source image is a downscaled version of a larger image obtained using an imaging modality; the source image is sufficiently large to reveal anatomic features associated with the abnormal condition.

In another aspect, the invention pertains to a mobile device configured to represent a tissue segmentation from a source digital image. In various embodiments, the mobile device comprises a processor; a computer memory comprising a first image buffer for storing a source digital image of an anatomic region and a second image buffer for storing a digital tissue segmentation image visually indicating regions of interest corresponding to an abnormal condition associated with at least portions of the anatomic region; and a touchscreen in operative communication with the processor for (a) displaying a first one of the source digital image or the tissue segmentation image, (b) receiving a gestural command and, in response, changing a magnification of the displayed first image, and (c) in response to a toggle command, displaying the other image at a substantially identical magnification level and in registration with the first image.

In some embodiments, the processor is configured to generate the tissue segmentation, whereas in other embodiments, the tissue segmentation is generated remotely and the processor is configured to receive the tissue segmentation and cause display thereof on the mobile device. The digital image may be represented at a plurality of resolutions related to each other via at least one geometric transformation. The processor may be configured to sense an increase in magnification of a displayed image on the mobile device and, in response thereto, to obtain and replace the displayed image with corresponding subject matter from a higher-resolution representation thereof.

In various embodiments, the processor is further configured to respond to an increase in magnification of a displayed digital tissue segmentation by replacing the displayed digital tissue segmentation with corresponding subject matter from a higher-resolution representation thereof.

The digital tissue segmentation may include a plurality of color overlays or outlines each associated with a probability range for the abnormal condition and superimposed on corresponding regions of the digital image. Alternatively or in addition, the digital tissue segmentation may include a plurality of overlays or outlines designating, and colorwise distinguishing, high-precision regions of interest and high-recall regions of interest superimposed on corresponding regions of the digital image.

In yet another aspect, the invention relates to a server for interacting with a mobile device and handling images for display thereon. In various embodiments, the server comprises a processor and a computer memory for storing a high-resolution image of an anatomic region and a mapping between the high-resolution image and a lower-resolution image of the anatomic region. The processor is configured to receive data specifying a portion of the lower-resolution image and, in response, to retrieve a corresponding portion of the high-resolution image and make the corresponding portion available to another device for display thereon. The other device may be, for example, a mobile device and the processor may retrieve and make the corresponding portion available in response to a command issued by the mobile device.

In various embodiments, the processor is further configured to generate, from the high-resolution image, a digital tissue segmentation visually indicating regions of interest corresponding to an abnormal condition associated with at least portions of the anatomic region, and to transmit the tissue segmentation image to another device at a lower resolution.

In some embodiments, the processor is further configured to computationally analyze one or more regions of interest to identify a classification subtype associated therewith.

Still another aspect of the invention pertains to a method of computationally representing a tissue segmentation image from a source digital image. In various embodiments, the method comprises, at a server, computationally generating (i) from a source digital image of an anatomic region, a tissue segmentation image visually indicating regions of interest corresponding to an abnormal condition associated with at least portions of the anatomic region, and (ii) a mapping between at least one of the source digital image or the tissue segmentation image and at least one lower-resolution version thereof; and on a mobile device, (i) alternately displaying each of the source image and the tissue segmentation image in registration at a gesturally selected magnification level and at a first resolution level, and (ii) replacing the displayed image with a corresponding portion of a higher-resolution version thereof obtained from the server.

The method may further comprise receiving, at the server, coordinates from the mobile device specifying a displayed portion of the source image or the tissue segmentation image and responsively making a corresponding portion of the higher-resolution image available to the mobile device. The server may be further configured to computationally analyze one or more regions of interest to identify a classification (e.g., disease) subtype associated therewith and to transmit the classification subtype to the mobile device for display thereon.

In some embodiments, the server is configured to generate the tissue segmentation image using a convolutional neural network, an object detector, or both. Coordinates of the image displayed on the mobile device may be received at the server without action by a user of the mobile device, or may be received at the server upon action taken on the mobile device (e.g., tapping a touchscreen icon, label or image feature) by a user thereof.

Yet another aspect of the invention relates to a method of computationally generating a tissue segmentation from a digital image of an anatomic region. In various embodiments, the method comprises the steps of computationally generating a plurality of overlapping subimage regions of the digital image; computationally sifting the subimage regions in accordance with a visual criterion; computationally generating classification probabilities for the sifted subimage regions, the classification probabilities corresponding to first and second tissue types; computationally generating the tissue segmentation from subimage regions whose classification probabilities specify a first of the at least two tissue types; and further computationally analyzing the subimage regions whose classification probabilities specify the first tissue type to generate classification probabilities corresponding to subtypes of the first tissue type.

In still another aspect, the invention pertains to an image-processing system for computationally generating a tissue segmentation from a source digital image of an anatomic region. In various embodiments, the system comprises a processor; a computer memory; a first image buffer for storing a source image; a tiling module for computationally generating a plurality of overlapping subimage regions of the source digital image; a subimage analyzer for computationally sifting the subimage regions in accordance with a visual criterion; a first classifier, executed by the processor, for computationally generating classification probabilities for the sifted subimages, the classification probabilities corresponding to first and second tissue types; a mapping module for computationally generating the tissue segmentation from subimage regions whose classification probabilities specify a first of the at least two tissue types; and a second classifier, executed by the processor, for computationally analyzing the subimage regions whose classification probabilities specify the first tissue type to generate classification probabilities corresponding to subtypes of the first tissue type.

As used herein, the term “substantially” or “approximately” means ±10%, and in some embodiments, ±5%. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### DESCRIPTION OF THE DRAWINGS

The foregoing discussion will be understood more readily from the following detailed description of the disclosed technology, when taken in conjunction with the following drawings, in which:

FIG. 1 schematically illustrates a representative hardware architecture according to embodiments of the invention.

FIG. 2 illustrates two-dimensional overlap among subimages.

FIG. 3 is a workflow diagram schematically depicting a representative division of functionality between a mobile device and a server.

### DESCRIPTION

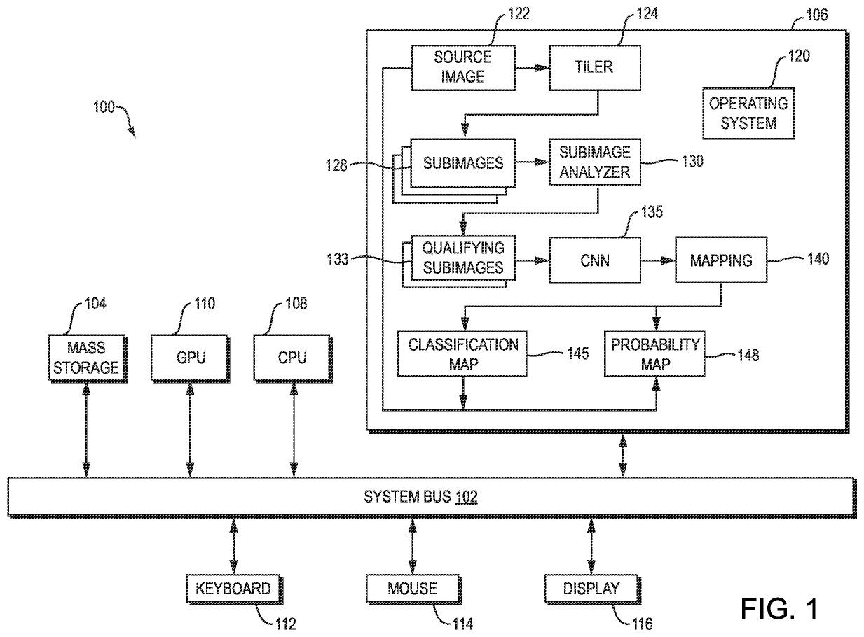

Refer first to FIG. 1, which illustrates a representative system 100 implementing an embodiment of the present invention; the system 100 may be a computer such as a server, as discussed below, but may instead be a mobile device. As indicated, the system 100 includes a main bidirectional bus 102, over which all system components communicate. The main sequence of instructions effectuating the functions of the invention and facilitating interaction between the user and the system reside on a mass storage device (such as a hard disk, solid-state drive or optical storage unit) 104 as well as in a main system memory 106 during operation. Execution of these instructions and effectuation of the functions of the invention are accomplished by a central processing unit (“CPU”) 108 and, optionally, a graphics processing unit (“GPU”) 110. The user interacts with the system using a keyboard 112 and a position-sensing device (e.g., a mouse) 114. The output of either device can be used to designate information or select particular areas of a screen display 116 to direct functions to be performed by the system. Alternatively, the screen display 116 may be a touchscreen.

The main memory 106 contains instructions, conceptually illustrated as a group of modules, that control the operation of CPU 108 and its interaction with the other hardware components. An operating system 120 directs the execution of low-level, basic system functions such as memory allocation, file management and operation of mass storage devices 104. At a higher level, a source image 122, stored (e.g., as a NumPy array) in an image buffer that may be a partition of main memory 106, is processed by a tiler module 124 to produce a plurality of subimage portions (or “tiles”) 128 of source image 122 based on a user-specified or default overlap factor. Tiles 128 may be stored in a storage device 104 along with coordinates specifying their locations in source image 122.

An analyzer 130 sifts subimages 128 according to a visual criterion, as described in greater detail below, to identify the subimages 133 that satisfy the criterion. The qualifying subimages 133 are analyzed by a CNN 135 (or other classifier, such as an attention network) that has been trained for the classification task of interest. CNN 135 may be straightforwardly implemented without undue experimentation. Python/Keras code for a suitable five-layer CNN architecture may be found at https://github.com/stevenjayfrank/A-Eye, the contents of which are incorporated by reference herein.

CNN 135 computes a classification probability for each qualifying subimage 133. A mapping module 140 builds a classification map 145 by computing the average probability associated with each classified pixel across all subimages that include that pixel, or otherwise combining pixel-level probabilities as described below. From classification map 145, mapping module 140 generates the probability map 148 based on the final probability value of each classified pixel and the color associated with that value. Because only part of the original source image may have associated probability levels (since, usually, not all subimages satisfy the visual criterion), it may be useful for probability map 148 to represent source image 122 as a grayscale (or line or other monochromatic) image with colors overlaid translucently where probabilities were obtained. Alternatively, identified regions may be outlined in, rather than filled with, a color indicative of the probability level. These and other alternatives are straightforwardly implemented in accordance with well-known techniques.

Classification map 145 and probability map 148 may be stored in memory 106 as data arrays, image files, or other data structure, but need not be distinct. Instead, probability map 148 may be generated directly from the source image (e.g., in grayscale format) and average (or otherwise combined) pixel-level classification probabilities as these are computed—i.e., the probability and classification maps may be the same map.

In one embodiment, tiler 124 generates subimage tiles 128 of specified dimensions from a source image 122 by successive identification of vertically and horizontally overlapping tile-size image regions. The Python Imaging Library, for example, uses a Cartesian pixel coordinate system, with (0,0) in the upper left corner. Rectangles are represented as 4-tuples, with the upper left corner given first; for example, a rectangle covering all of an 800×600 pixel image is written as (0, 0, 800, 600). The boundaries of a subimage of width=w and height=h are represented by the tuple (x, y, x+w, y+h), so that x+w and y+h designate the bottom right coordinate of the subimage.

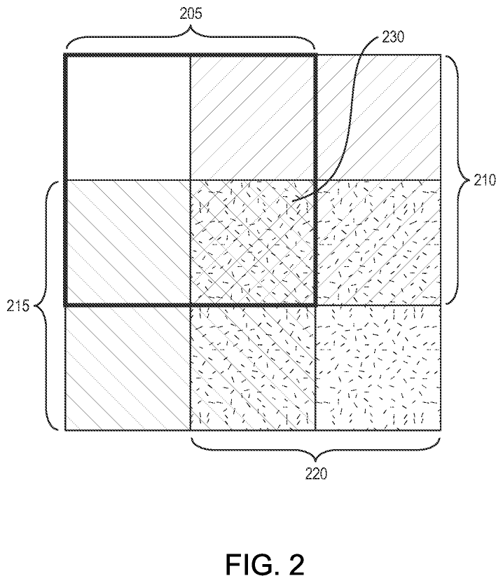

The tile overlap factor may be defined in terms of the amount of allowed overlap between vertically or horizontally successive subimages; hence, an overlap factor of ½ results in 50% vertical or horizontal overlap between consecutive subimages. This is illustrated in FIG. 2. Tile pairs 205, 210 and 215, 220 have 50% horizontal overlap (with the border of tile 205 being emphasized for clarity). In addition, tile pair 215, 220 has 50% vertical overlap with tile pair 205, 210. This two-dimensional overlap results in a central region 230 where all four tiles 205, 210, 215, 220 overlap and may contribute, by averaging or other combination, to a classification probability. The greatest number of overlapping images occupy the central region 230, which, as overlap increases, diminishes in size but increases in terms of the number of contributing subimages. More importantly, increasing overlap means that more of the area of any single tile will overlap with one or more other tiles, so that more pixels of any tile will receive probability contributions from other tiles with consequent reduction in classification error; consequently, if only a minority of tiles are misclassified, the effect of overlap by properly classified tiles will overwhelm the misclassification error and the resulting probability map will have high accuracy. Typical overlap factors exceed 50%, e.g., 60%, 70%, 80%, or even 90% or more along both dimensions.

Once the tiles are generated, they are sifted in accordance with a visual criterion with the objective of eliminating tiles that are not meaningful for classification. In one embodiment, the visual criterion is image entropy. From the purview of information theory, image entropy represents the degree of randomness (and therefore information content) of the image pixel values, just as the entropy of a message denotes (as a base-2 log) the amount of useful, nonredundant information that the message encodes:

$$H = - {\sum }_{k} {p}_{k} {log}_{2} ( {p}_{k} )$$

In a message, pₖ is the probability associated with each possible data value k. For an image, local entropy is related to the complexity within a given neighborhood, sometimes defined by a structuring element such as a circular or square region, or the entire image. Thus, the entropy of a grayscale image (or one channel of a color (e.g., RGB) image) can be calculated at each pixel position (i,j) across the image. To the extent that increasing image entropy correlates with increasingly rich feature content captured in the convolutional layers of a CNN, it provides a useful basis for selecting tiles. In one implementation, only those tiles whose entropies equal or exceed the entropy of the whole image are retained. Although no subimage will contain as much information content as the original, a subimage with comparable information diversity may pack a similar convolutional punch, so to speak, when processed by a CNN. In some embodiments, depending on the distribution of tile entropies, the discrimination criterion may be relaxed in order to increase the number of qualifying tiles. Because of the logarithmic character of the entropy function, even a slight relaxation of the criterion can result in many more qualifying tiles. For example, the criterion may be relaxed by 1% (to retain tiles with image entropies equal to or exceeding 99% of the source image entropy), or 2%, or 3%, or 4%, or 5%, or up to 10%. Tile sifting using image entropy is further described in Frank et al., “Salient Slices: Improved Neural Network Training and Performance with Image Entropy,” Neural Computation, 32(6), 1222-1237 (2020), which is incorporated by reference herein.

Another suitable approach to tile sifting uses a background threshold criterion, retaining only tiles with a proportion of background below a predetermined limit. Images of pathology slides, for example, typically have white or near-white backgrounds. But the tissue of interest may also have white features, gaps or inclusions. Hence, while the presence of any background can adversely affect training and classification accuracy, eliminating all tiles containing regions that might potentially be background risks discarding anatomy critical to classification. As a result, the minimum background threshold is generally set at 50% or higher, e.g., 60%, 70%, 80%, or even 90%; the optimal threshold depends on the amount of background-shaded area that may appear in non-background regions.

One approach to background identification and thresholding is to convert a colored tile to grayscale and count pixels with color values corresponding to background, e.g., white or near-white pixels. For example, an RGB image has three color channels and, hence, three two-dimensional pixel layers corresponding to red, blue, and green image components. In an eight-bit grayscale image, a pixel value of 255 represents white. To allow for some tonal variation from pure white arising from, for example, the source imaging modality, any pixel in any layer with a value above, e.g., 240 may be considered background. Summing the number of such pixels and dividing by the total number of pixels yields the background fraction. Only tiles with background fractions below the predetermined threshold are retained.

Still another suitable visual criterion is image density. If regions of interest for classification purposes are known to have image densities above a minimum, that minimum may be used as a discrimination threshold to sift tiles. See, e.g., the '406 patent mentioned above.

With renewed reference to FIG. 1, once tiles have been sifted and qualifying tiles 133 identified and stored in volatile and/or nonvolatile storage, they are used either to train CNN 135 or are presented to a trained CNN as candidate images for classification. The output of CNN 135 is generally a classification probability. In some instances, the classification is binary (e.g., cancerous or benign, adenocarcinoma or squamous cell carcinoma, etc.) and the decision boundary lies at, e.g., 0.5, so that output probabilities at or above 0.5 correspond to one classification and output probabilities below 0.5 reflect the other classification. In other instances, there are multiple output classifications and a “softmax” activation function maps CNN output probabilities to one of the classes.

For ease of illustration, consider binary classification of a histology slide that may contain either or both of two types—“type 1” and “type 2”—of cancerous tissue. The slide, possibly after initial resizing (e.g., downsampling to a lower resolution), is decomposed into overlapping subimages 133, which are sifted as described above. The sifted subimages are processed by CNN 135, which has been trained to distinguish between type 1 and type 2 cancers. CNN 135 assigns a classification probability p to each subimage, with probabilities in the range 0.5≤p<1.0 corresponding to type 1 and probabilities in the range 0<p<0.5 corresponding to type 2 (assuming a decision boundary at 0.5). Each individual subimage may contain only a small amount of type 1 or type 2 tissue, yet the entire subimage receives a unitary probability score. As a result, the score assigned to an individual subimage may be skewed so as, for example, to ignore type 1 and/or type 2 tissue that is present but in too small a proportion to trigger the proper classification. With sufficient overlap and pixel-level averaging, this classification error will be mitigated as overlapping subimages containing progressively greater proportions of the type 1 and/or type 2 tissue contribute to the average pixel-level probabilities.

In various embodiments, a pixel-level probability map is defined to reflect average probabilities across all classified subimages. For example, in Python, a 3D m×n×d NumPy array of floats may be defined for an m×n source image, with the parameter d corresponding to the number of classified subimages (which were identified as satisfying a visual criterion). At each level d, the array is undefined or zero except for the region corresponding to one of the classified subimages, and all array values in that 2D region are set to the classification probability computed for the subimage. The probability map is an m×n array, each value [i,j] of which is equal to some combination of all nonzero values [i,j,d:] of the 3D array, e.g., the average of all nonzero values [i,j] over the d-indexed axis. The greater the degree of subimage overlap, the deeper the number of nonzero values will extend through the d-indexed axis and, therefore, the more probability values (from overlapping subimages) that will contribute to the combined value at any point of the probability map, enhancing classification accuracy for that point. Points in the probability map corresponding to points in the 3D array with no nonzero values over the d-indexed axis—i.e., where the source image lacked sufficient image entropy to generate a subimage satisfying the criterion—may be left undefined. The probability map, therefore, is a map of pixelwise classification probabilities. The probability map may be dense (i.e., have values over most of the source image) or sparse (with relatively few defined values) depending on the amount of visual diversity in the source image and the number of qualifying tiles left after sifting.

In another approach, which may be applied in addition to or instead of the tile-based approach noted above, an object detector may be used to find image features corresponding to tissue abnormalities. This approach is useful if the source image is relatively small and/or downscaling does not materially affect the ability of the object detector to identify ROIs. For example, an object detector may accept as input the entire source image 122, a rescaled version thereof or a portion thereof. Suitable object-detection systems include RCNN, Fast RCNN, Faster RCNN, Mask RCNN, pyramid networks, EfficientDet, DETR, and YOLO (e.g., any of YOLO versions v1-v8). Object-detection algorithms may predict the dimensions and locations of bounding boxes surrounding objects that the algorithm has been trained to recognize (although some, like Mask RCNN, predict object contours). Bounding boxes or contours having probability scores below a threshold may be dropped. For example, the object detector may be used to identify abnormal tissue regions with high precision, but the result may have lower sensitivity than that obtainable using a CNN. Accordingly, ROIs identified by the object detector may be marked as high probability and those identified by the CNN (e.g., with a reduced threshold to enhance sensitivity) may be marked as lower probability. This approach may be advantageously used to prioritize medical images for review. For example, a collection of mammograms, or the individual images in a multi-image 3D mammogram, may be ranked in terms of priority by the number of high-precision pixels, or by a weighted sum of high-precision and high-recall pixels, in each image.

While object-detection algorithms have proven themselves capable of distinguishing among clearly different object types, they may have more difficulty distinguishing among tissue types whose differences are subtle, or where an image has limited information content. For example, chest X-rays may reveal one or more of numerous conditions such as atelectasis, consolidation, pleural effusion, pulmonary fibrosis, aortic enlargement, cardiomegaly, etc. These conditions may share various visual similarities in an X-ray image, which is not only grayscale but may have limited resolution or imaging sensitivity. Similarly, mammograms may contain potentially malignant masses that are difficult to distinguish visually, given limited resolution and the absence of color, from fibrous breast tissue. In such cases, it may be useful to apply an ensemble of object-detection algorithms and combine the resulting predictions using a combination technique such as weighted boxes fusion, soft nms, or other suitable technique.

The probability map may be color-coded, with different colors assigned to discrete probability ranges. For example, the color coding may follow the visible spectrum, with low probabilities corresponding to blue and high probabilities represented by red, and intermediate probability ranges assigned to intermediate spectral colors. The number of colors used (i.e., how finely the probability range of 0 to 1 is partitioned) depends on the classification task and how meaningful small probability gradations are for the viewer. Alternatively or in addition, regions may be colored to indicate sensitivity vs. precision or specificity. In some embodiments, high-specificity regions (e.g., identified by an object detector) are marked red while high-sensitivity regions (e.g., identified by CNN 135) are marked yellow. The high-specificity regions tend to surround target abnormalities tightly; the high-sensitivity regions may be more diffuse and occupy more of the image, but will capture ROIs that may be absent from the high-specificity regions. The color marking may be in the form of an overlay or contour boundary surrounding a ROI.

The classification need not be binary. For example, CNN 135 may be trained with subimages 128 corresponding to three types of tissue, e.g., normal tissue and two distinct types of malignant tumor. Probabilities may be computed according to, for example, a softmax activation function. Pixel-level probabilities from overlapping tiles can be averaged as described above or, because the softmax function is a ratio of exponentials, the mean may be weighted or otherwise adjusted. More simply, the softmax probabilities associated with each pixel may be summed and the class label corresponding to the largest sum (identified, for example, using the argmax( ) function to select a label index) assigned to the pixel with, e.g., a probability of 1. Following these assignments, classification map 145 will have pixels with class labels and associated probability values of 1, and the remaining pixels will have probability values of 0.

Alternatively, the tasks of segmentation and subtyping may be handled separately as a sequence of binary classification tasks instead of a softmax function. This approach preserves the conventional probabilities associated with each task. For example, in the case of normal tissue and two distinct types of malignant tumor, a first CNN 135 may be trained to discriminate between normal tissue and malignant tissue of both types, and a second CNN 135 may be trained to discriminate between the two tumor types. A source image 122 may be decomposed into tiles that are sifted and presented to the first CNN 135, which identifies a set of tiles corresponding to tumor tissue. These tiles may be analyzed and used to create a probability map 148 as described above. In addition, they may be analyzed by the second CNN 135 to classify the tumor in terms of its subtype. For example, the classification probabilities generated by the second CNN 135 may be aggregated in a probability framework (e.g., averaged or weighted) to produce an overall subtype classification.

In some instances, the tile size corresponding to segmentation accuracy may differ from that producing best classification performance—e.g., segmentation accuracy favors smaller tile sizes for maximum resolution while the optimal tile size for classification may depend on the distribution of relevant tissue abnormalities within a diseased region. In such cases, segmentation may be performed first (using the first CNN 135) and used to create a binary mask, which is applied to the source image to isolate the predicted abnormal region(s). Tiles at the optimal classification size may be obtained from the isolated region, sifted, and analyzed using the second CNN 135 to classify the abnormal region.

If the image to be analyzed is known to contain only one of multiple classifications, the dominant label among labeled pixels—that is, the label with the most pixel assignments—may be identified, and in some implementations, only pixels having that label are mapped in probability map 148. If the subimage size is small enough, the dominant label can be assessed at a subimage level, and the pixels of classification map 145 corresponding to those of each subimage classified with the dominant label are assigned a probability of 1. These pixels may be assigned a monochromatic color and translucently superimposed over the grayscale version of source image 122 (or used to form colored boundaries on the image) to generate the final probability map 148. Thus, in this case, combining class probabilities means assigning a value of 1 to any pixel intercepted by any number of tiles having the dominant label (and assigning a value of 0 otherwise).

If the image might validly have multiple classifications, on the other hand, these classifications may be mapped in different colors on a single probability map 148. Alternatively, multiple probability maps each colored to show one of the classifications may be generated. For example, CNN 135 may be trained to discriminate among multiple tumor types, but suppose it is known that any malignant histology sample can contain only one type of tumor. In that case, the image of a new sample may be tiled and sifted in accordance with a visual criterion, and the sifted tiles presented to CNN 135 for classification. Due to error, the resulting classifications may incorrectly include more than one tumor type. If CNN 135 has been properly trained, the correct classification type will predominate among tiles classified in one of the malignant categories (as opposed to classification as normal tissue). The minority tiles may therefore be ignored and only the dominant tumor tiles mapped. Since the minority tiles are excluded altogether rather than being averaged with the dominant tiles, there is no need for probability-based color coding; the dominant tiles may be overlaid in a single color on a grayscale version of the sample image, producing a tissue segmentation indicating the location and type of tumor in the sample—that is, the union of all dominant tiles will be colored monochromatically in probability map 148.

Alternatively or in addition, image entropy may be used to produce boundary constraints rather than a unitary criterion that either is or is not satisfied. This is particularly useful in creating tissue segmentations, which in this context refers to probability maps distinguishing between two or more different tissue types. Frequently, the distinction is between normal and abnormal (e.g., diseased) tissue. The tissue segmentation may take the form of a colored probability map or a binary mask that, e.g., is black for all normal tissue areas and white or transparent for all abnormal tissue regions. Such a mask is considered a probability map as the latter term is used herein. The segmentation may also take the form of the source image or grayscale version thereof with ROIs marked, e.g., with colored dots, boundary lines or other indicators. For example, an object detector may be trained to detect and distinguish between cancerous and normal cells. The centroids of the detected cells may be indicated by differently colored dots corresponding to cell type or disease status (e.g., diseased vs. normal). Alternatively, a similar result can be achieved by producing a segmentation of the image, or non-overlapping portions thereof, using a segmentation architecture such as U-Net or a fully convolutional neural network; these are well-suited to identifying sharply defined tissue structures such as cells. The segmentation model may be trained to detect different cell classes, or a single class including all cells that are classified using a trained classification architecture such as EfficientNet or ResNet. Different types of identified cells may be counted to obtain a measure of, e.g., tumor cellularity—that is, the proportion of tumor cells in a tissue sample, which may have clinical significance.

In one implementation, training images are prepared using segmentation masks that occlude normal (e.g., non-tumor) portions of an image. These masks may be generated manually, by trained experts, or in an automated fashion. The masks allow the abnormal (e.g., tumor) portions of a slide image to be extracted, and the resulting tumor-only images may be downsampled as described above and their image entropies computed. The maximum and minimum entropies of the images (or, if desired, of tiles created from the images) may be treated as boundaries or “rails” within which a candidate tile must fall in order to qualify as usable. Sifting in accordance with this criterion preliminarily eliminates tiles unlikely to correspond to tumor tissue. Thus, an image of a histology slide to be classified and/or mapped may be downsampled, tiled, and the tiles sifted using the previously established entropy boundaries. The remaining tiles may then be analyzed by CNN 135.

If the CNN has been trained to distinguish between normal and abnormal tissue as a binary classification, the entropy rails serve as a preprocessing check to exclude normal tissue tiles that might have been misclassified as tumor tiles. The tiles having the classification of interest (e.g., abnormal) may be mapped as discussed above; the union of all such tiles, as mapped, constitutes the tissue segmentation, which may be overlaid onto the original image or may instead be output as a binary mask. For example, in a binary classification, the union of all abnormal tissue tiles may overlaid onto the original image as white or transparent, with the remainder of the image rendered as black. Whether white/transparent or colored, the union of overlapping tiles represents an approximation of the abnormal tissue region—i.e., a tissue segmentation. The classification probabilities for overlapping tiles may, in some embodiments, be combined at a pixel level as described above. But in other embodiments, a simple union operation over all appropriately classified tiles is employed.

Due to the tile geometry, the segmentation region will have stepped edges that appear jagged. The edges may be smoothed with a median or other smoothing filter. (It should be noted that smoothing may be applied to any type of probability map described herein.) Furthermore, tile size limits the contour accuracy of the probability map; the larger the tile size, the more the edges of the map will spill over into the oppositely classified tissue region (e.g., into normal tissue). From a clinical perspective such overinclusiveness is perhaps to be preferred to the alternative, but in any case, the tile size is generally dictated by what works best for the overall task of classifying tissue. To compensate for this spillover effect, it is possible to apply isomorphic shrinkage to the mapped regions; the larger the tile size, the greater the degree of shrinkage that may be applied before or after smoothing. The optimal amount of image resizing for a given tile size is straightforwardly obtained without undue experimentation.

If CNN 135 has been trained to distinguish between normal and multiple types of abnormal tissue, the probability map may be based on the dominant abnormal tissue type as described above, i.e., the minority tiles may be ignored and only the dominant tiles mapped. Alternatively, all tiles classified as either type of abnormal tissue may be mapped (e.g., tiles corresponding to both the dominant and minority abnormal tissue types). The latter approach may be preferred if abnormal tissue tiles are more likely to be misclassified as the wrong type of abnormal tissue than as normal tissue.

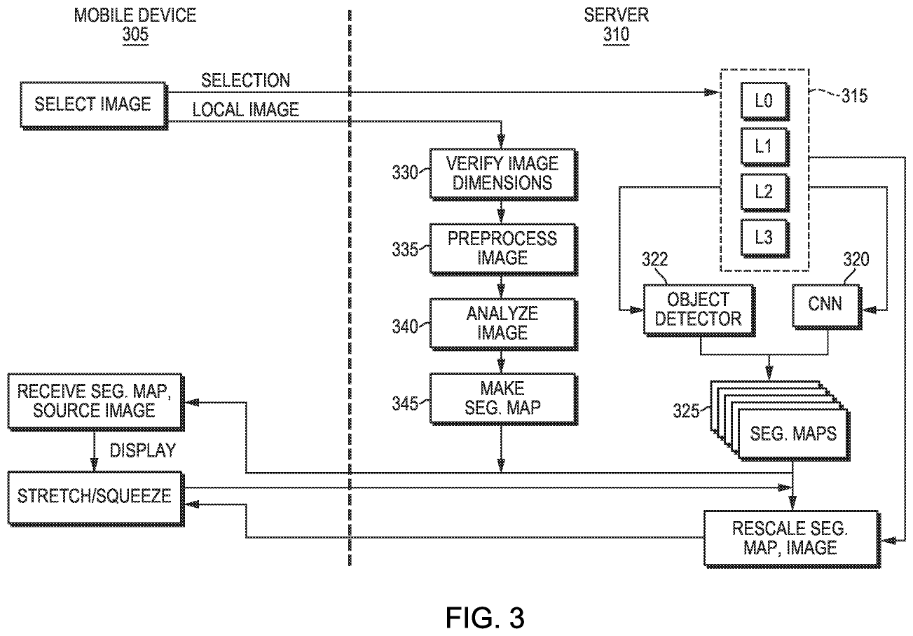

With reference to FIG. 3, the functionality described above may be shared between a mobile device 305 and a conventional server 310, which may be in communication over a network via a conventional network interface; for example, server 310 may be a web server and the network may be the Internet or the public telecommunication infrastructure. The user first selects a medical image on mobile device 305. The medical image may be stored locally on mobile device 305 and uploaded to server 310, or may instead be resident on server 310, in which case the user taps a screen feature (e.g., an image thumbnail) and the user's selection is transmitted to server 310. The selected medical image may be a whole-slide image, an X-ray, a tomographic image, a mammogram, or other digital representation of an internal and/or external anatomic region or a slide (e.g., a biopsy slide).

A source image 315 may be stored on server 310 at a plurality of resolutions. In some cases, a single discrete file holds multiple versions of the same image at different resolutions. For example, TIFF is a tag-based file format for storing and interchanging images. A TIFF file can hold multiple images in a single file. The term “Pyramid TIFF” refers to a TIFF file that wraps a sequence of bitmaps each representing the same image at increasingly coarse spatial resolutions. The individual images may be compressed or tiled. Similarly, SVS files are multi-page TIFF files that store a pyramid of smaller TIFF files of an original image. The different resolutions are related in terms of pixel count and downsample factor, and for medical images obtained using microscopy, a magnification factor. Data characterizing a representative set of multilevel files, each containing the same image at different resolutions, is set forth in Table 1.

TABLE 1

| | Average | | |
|---|---|---|---|
| Level | Dimensions (pixels) | Downsample Factor | Magnification |
| L0 | 116,214 × 88,094 | 1 | 40× |
| L1 | 29,053 × 22,023 | 4 | 20× |
| L2 | 7263 × 5505 | 16 | 10× |
| L3 | 3498 × 2662 | 32 | 5× |

The optimal level to use for segmentation analysis depends on the application. Some diseases manifest in large enough regions of, for example, a biopsy slide that even a relatively coarse resolution (e.g., L3) is sufficient for analysis; the image may be tiled as described above and analyzed by a CNN 320 trained on similarly sized tiles drawn from images of similar or identical resolution; alternatively or in addition, a still coarser version of source image 315 may be analyzed in whole by an object detector 322 trained on similarly sized images. In other embodiments, source image 315 is stored as separate files, each at a different resolution, in an image library.

The output of CNN 320 or object detector 322 may be used as (or to generate) a tissue segmentation map 325 at the resolution of the analyzed image. The segmentation map may be scaled to the other stored resolutions and, if desired, to intermediate resolutions. For example, a binary mask or color overlay may simply be scaled geometrically; enlargement results in no loss of resolution because the mask or overlay regions are graphic entities rather than image data. These elements may be stored separately or applied to the differently scaled source images, in native or grayscale format, and the resulting mapped images stored separately as indicated in FIG. 3. The latter approach requires more server storage but enables rapid access to differently scaled images as the user of mobile device 305 stretches or squeezes the viewed image. The former approach involves creating differently scaled segmentations on the fly, which may be preferred for large images, particularly if the user is not expected to dramatically and frequently stretch or squeeze the images so as to traverse multiple image scales.

Server 310 may implement the functionality described above in connection with system 100. Hence, server 310 may process an incoming image from mobile device 305 by initially verifying that the image resolution corresponds to the resolution of images on which CNN 320 was trained (step 330), and adjusting the resolution as necessary. Server 310 may then perform various conventional preprocessing tasks such as equalization, contrast adjustment, cropping, removal of spurious or patient-identifying markings, stain normalization, etc. (step 335). Server 310 thereupon generates and sifts tiles from the selected image, analyzes them using CNN 320 (step 340), and generates a tissue segmentation map as described earlier (step 345); for example, the tissue segmentation map may highlight ROIs in different colors corresponding to probability levels of an abnormality. Further details are set forth in U.S. Patent Publ. No. 2023/0050168, filed on Sep. 14, 2022, the entire disclosure of which is hereby incorporated by reference. Alternatively or in addition, the received image may be analyzed (e.g., at a lower resolution following downscaling) by object detector 322. In the absence of previously stored images 315 corresponding to the received local image at different resolutions, server 310 is limited in terms of the additional image data it can supply as the user of mobile device 305 stretches the local image (which is, in this case, the highest-resolution image available to server 310). But server 310 can still perform the analytical and segmentation steps 330-345 that may otherwise be too computationally intensive for practical execution on mobile device 305.

The segmentation map may take various forms, as noted—e.g., it may have the same dimensions as the selected image, it may be a grayscale or color image with an overlay reflecting different probability levels, and it may be represented as an image (such as a bitmap or compressed—e.g., .jpg or .png—image) or as rendering instructions for producing a graphic overlay (e.g., a color probability map with filled or outlined regions). The segmentation map may be provided to mobile device 305 directly, via a network connection, a download link or other indirect means. If the source image was originally present on server 310 rather than mobile device 305, the source image may be provided to mobile device 305 along with the segmentation map at a resolution appropriate to convenient download and initial display.

The mobile device 305 is configured to permit the user to toggle between the selected image and the received tissue segmentation map. Mobile device 305 may allow the user to gesturally control image magnification (e.g., using pinch and stretch gestures) and toggle between substantially identically magnified versions of the source image and the tissue segmentation map. In this way, for example, the user may zoom in on a colored ROI and then toggle to the source image to inspect the anatomy more closely. This toggling function is straightforwardly implemented using, for example, dual image buffers and a conventional mobile application that acquires and applies the coordinates of a first displayed image to another image that replaces it. Alternatively, as noted, the segmentation map may be an overlay applied to the source image and defined in vectorized or geometric form (rather than as an image bitmap), or may even simply be rendering instructions for a filled or border overlay. Toggling between the source image and the segmentation map, therefore, may be no more than a trigger for applying the overlay to, or removing it from, the displayed source image (or a grayscale version thereof).

When the user stretches the displayed image, the resolution becomes coarser. To enable the user to see more detail, the coordinates of the displayed image portion are sent to the server following the user's stretch gesture. Based on these image coordinates, server 310 selects a higher-resolution version of the source image and corresponding segmentation map and, based on the mapping among stored images, sends higher-resolution content for display on mobile device 305. This may be implemented as follows. As noted earlier, source image 315 and corresponding segmentation maps 325 may be stored at multiple resolutions, e.g., L0-L3 shown in FIG. 3. The image initially passed to mobile device 305 may be, for example, the L3 version. Server 310 establishes a mapping between the images at different resolutions. In general, the mappings are geometric or coordinate transformations such as linear or affine transformations, enabling coordinates in one image to be mapped to corresponding coordinates in one or more other images. The server 310 may rescale the tissue segmentation image 325 that it generates, or may select from among previously generated images at different rescalings, before transmitting an image and its associated segmentation map to mobile device 305. The mappings among images may be stored as transformation matrices reflecting two-dimensional enlargement or contraction of all distances in a particular direction by a constant factor. For example, the mappings may be pairwise mappings between successive resolution levels. The image storage and mapping may precede interaction with and provision of image data to mobile devices.

When the user of the mobile device 305 changes the magnification of the viewed lower-resolution image (e.g., gesturally, as noted above), the coordinates of the currently displayed image portion may be transmitted to server 310, which uses the mapping to identify the corresponding portion of the image represented at a higher resolution. Server 310 thereupon returns this image portion to mobile device 305. Image-handling functionality on mobile device 305 causes this image portion to replace the displayed lower-resolution image portion, affording the user access to more anatomic detail. To the user stretching an image to examiner a point of detail, the enlarged image appears to come into better focus as the coarser subject matter is replaced by more highly detailed image data. If the user continues to stretch the image, corresponding subject matter from progressively higher-resolution image versions may be identified and transmitted to mobile device 305 for display thereon. As a result, the user is able to examine detail up to the resolution limit of the highest-resolution image stored on server 310.

The image-handling functionality on mobile device 305 may trim, resize or resample the received image portion so that it smoothly replaces its lower-resolution counterpart on the display; for example, the user may stop stretching the image at a magnification level intermediate between server-stored levels, so the image-handling functionality may resize the received image portion so it displays properly.

In some embodiments, the user of the mobile device 305 may be allowed to select a desired resolution for analysis on the server side, and may also select or upload the CNN 230 and/or object detector 322 used for analysis. It should also be stressed that it is not necessary for server 310 to store or actually handle the image being viewed on mobile device 305; it is only necessary for server 310 to have the mapping parameters relating the viewed image on the mobile device to the higher-resolution image it will analyze.

In some embodiments, replacement of the lower-resolution displayed image with the higher-resolution fragment thereof occurs upon user command. For example, an application executing as a running process on mobile device 305 (an “app”) may present a button graphic which, when tapped, causes transmission of image coordinates to server 310, which responsively retrieves and makes available (e.g., transmits) to mobile device 305 the corresponding fragment of the higher-resolution image. Tapping again may cause the app to replace the displayed higher-resolution fragment with the congruent portion of the lower-resolution image, enabling the user to once again stretch or squeeze the displayed image. Alternatively, the app may sense a stretch operation and, in response, automatically transmit image coordinates of the displayed image portion to server 310, which responsively retrieves and makes available to mobile device 305 the corresponding fragment of the higher-resolution image, which is then displayed. Because only a portion of the high-resolution image has been buffered on the mobile device, the user can stretch but not shrink the high-resolution image. Hence, when the app detects a pinch gesture on the device touchscreen that would require display of unavailable image data, it may replace the displayed higher-resolution fragment with the congruent portion of the lower-resolution image before shrinking the image (and displaying more of it) in response to the pinch gesture. Alternatively, the lower-resolution image data may be cached on mobile device 305. In still other embodiments, full images at multiple resolutions (e.g., two adjacent images and associated segmentation maps) and mappings (e.g., transformation matrices) therebetween may be downloaded to and cached on mobile device 305, enabling fast response to gestural changes in image magnification. Finally, a reduced image may created on mobile device 305 simply by downscaling the displayed image in real time in response to a pinch gesture.

It should be understood that the term “network” is herein used broadly to connote wired or, more typically, wireless networks of computers or telecommunications devices (such as wired or wireless telephones, tablets, etc.). For example, a computer network may be a local area network (LAN) or a wide area network (WAN). When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Networked computers may be connected over the Internet, an Intranet, Extranet, Ethernet, or any other system that provides communications. Some suitable communications protocols include TCP/IP, UDP, or OSI, for example. For wireless communications, communications protocols may include IEEE 802.11x (“Wi-Fi”), BLUETOOTH, ZIGBEE, IRDA, near-field communication (NFC), or other suitable protocol. Furthermore, components of the system may communicate through a combination of wired or wireless paths, and communication may involve both computer and telecommunications networks. For example, a user may establish communication with a server using a “smart phone” via a cellular carrier's network (e.g., authenticating herself to the server by voice recognition over a voice channel); alternatively, she may use the same smart phone to authenticate to the same server via the Internet, using TCP/IP over the carrier's switch network or via Wi-Fi and a computer network connected to the Internet.

In general, it is noted that computers (such as system 100 and server 305) typically include a variety of computer-readable media that can form part of system memory and be read by the processing unit. By way of example, and not limitation, computer-readable media may take the form of volatile and/or nonvolatile memory such as read-only memory (ROM) and random access memory (RAM). A basic input/output system (BIOS), containing the basic routines that help to transfer information between elements, such as during start-up, is part of operating system 120 and is typically stored in ROM. RAM typically contains data and/or program modules that are immediately accessible to and/or presently being operated on by a CPU (e.g., CPU 108). An operating system may be or include a variety of operating systems such as Microsoft WINDOWS operating system, the Unix operating system, the LINUX operating system, the MACINTOSH operating system, the APACHE operating system, or another operating system platform.

Any suitable programming language may be used to implement without undue experimentation the analytical, communication and data-handling functions described above. Illustratively, the programming language used may include without limitation, high-level languages such as C, C++, C#, Java, Python, Ruby, Scala, and Lua, utilizing, without limitation, any suitable frameworks and libraries such as TensorFlow, Keras, PyTorch, or Theano. Further, it is not necessary that a single type of instruction or programming language be utilized in conjunction with the operation of the system and method of the invention. Rather, any number of different programming languages may be utilized as is necessary or desirable. Additionally, the software can be implemented in an assembly language and/or machine language.

CPU 108 may be a general-purpose processor, e.g., an INTEL CORE i9 processor, but may include or utilize any of a wide variety of other technologies including special-purpose hardware, such as GPU 110 (e.g., an NVIDIA 2070), a microcontroller, peripheral integrated circuit element, a CSIC (customer-specific integrated circuit), ASIC (application-specific integrated circuit), a logic circuit, a digital signal processor, a programmable logic device such as an FPGA (field-programmable gate array), PLD (programmable logic device), PLA (programmable logic array), smart chip, or any other device or arrangement of devices that is capable of implementing the steps of the processes of the invention.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

1. A method of computationally representing a tissue segmentation from a source digital image, the method comprising the steps of:
computationally generating, from a source digital image of an anatomic region, a digital tissue segmentation visually indicating regions of interest corresponding to an abnormal condition associated with at least portions of the anatomic region; and
alternately displaying the source image and the tissue segmentation in registration on a mobile device at a gesturally selected magnification level.

2. The method of claim 1, further comprising the steps of:
representing the source digital image at a plurality of resolutions;
relating the representations of the source image at the different resolutions via at least one geometric transformation; and
responsive to an increase in magnification of a displayed image on the mobile device, replacing the displayed image with corresponding subject matter from a higher-resolution representation thereof.

3. The method of claim 2, further comprising the steps of:
computationally generating the digital tissue segmentation from the source digital image at a selected one of the plurality of resolutions;
applying the digital tissue segmentation to the source image at other resolutions; and
responsive to an increase in magnification of a displayed digital tissue segmentation on the mobile device, replacing the displayed digital tissue segmentation with corresponding subject matter from a higher-resolution representation thereof.

4. The method of claim 2, wherein the source image is stored at multiple resolutions at a server in communication with the mobile device, the server being configured to select the higher-resolution source image based on the increased magnification and to communicate a portion of the higher-resolution image to the mobile device for display thereon.

5. The method of claim 2, wherein the source image is stored at multiple resolutions on the mobile device, the mobile device being configured to replace the displayed image with a higher-resolution version of the displayed subject matter obtained from a higher-resolution source image.

6. The method of claim 1, wherein the tissue segmentation is generated remotely and communicated to the mobile device for display, alternately with the source image, thereon.

7. The method of claim 1, wherein the digital tissue segmentation includes a plurality of color overlays each associated with a probability range for the abnormal condition and superimposed on corresponding regions of the digital image.

8. The method of claim 1, wherein the digital tissue segmentation includes a plurality of overlays designating, and colorwise distinguishing, high-precision regions of interest and high-recall regions of interest superimposed on corresponding regions of the digital image.

9. The method of claim 1, further comprising the step of computationally analyzing one or more regions of interest to identify a classification subtype associated therewith.

10. A mobile device configured to represent a tissue segmentation from a source digital image, the mobile device comprising:
a processor;
a computer memory comprising a first memory partition for storing a source digital image of an anatomic region and a second memory partition for storing a digital tissue segmentation image visually indicating regions of interest corresponding to an abnormal condition associated with at least portions of the anatomic region; and
a touchscreen in operative communication with the processor for (a) displaying a first one of the source digital image or the tissue segmentation image, (b) receiving a gestural command and, in response, changing a magnification of the displayed first image, and (c) in response to a toggle command, displaying the other image at a substantially identical magnification level and in registration with the first image.

11. The mobile device of claim 10, wherein the processor is configured to generate the tissue segmentation.

12. The mobile device of claim 10, wherein the tissue segmentation is generated remotely and the processor is configured to receive the tissue segmentation and cause display thereof on the mobile device.

13. The mobile device of claim 11, wherein:
the digital image is represented at a plurality of resolutions related to each other via at least one geometric transformation; and
the processor is configured to sense an increase in magnification of a displayed image on the mobile device and, in response thereto, to obtain and replace the displayed image with corresponding subject matter from a higher-resolution representation thereof.

14. The mobile device of claim 13, wherein the processor is further configured to respond to an increase in magnification of a displayed digital tissue segmentation by replacing the displayed digital tissue segmentation with corresponding subject matter from a higher-resolution representation thereof.

15. The mobile device of claim 10, wherein the digital tissue segmentation includes a plurality of color overlays each associated with a probability range for the abnormal condition and superimposed on corresponding regions of the digital image.

16. The mobile device of claim 10, wherein the digital tissue segmentation includes a plurality of overlays designating, and colorwise distinguishing, high-precision regions of interest and high-recall regions of interest superimposed on corresponding regions of the digital image.

17. A method of computationally representing a tissue segmentation image from a source digital image, the method comprising the steps of:
at a server, computationally generating (i) from a source digital image of an anatomic region, a tissue segmentation image visually indicating regions of interest corresponding to an abnormal condition associated with at least portions of the anatomic region, and (ii) a mapping between at least one of the source digital image or the tissue segmentation image and at least one lower-resolution version thereof; and
on a mobile device, (i) alternately displaying each of the source image and the tissue segmentation image in registration at a gesturally selected magnification level and at a first resolution level, and (ii) replacing the displayed image with a corresponding portion of a higher-resolution version thereof obtained from the server.

18. The method of claim 17, further comprising receiving, at the server, coordinates from the mobile device specifying a displayed portion of the source image or the tissue segmentation image and responsively making a corresponding portion of the higher-resolution image available to the mobile device.

19. The method of claim 17, wherein the server is further configured to computationally analyze one or more regions of interest to identify a classification subtype associated therewith and to transmit the classification subtype to the mobile device for display thereon.

20. The method of claim 17, wherein the server is configured to generate the tissue segmentation image using at least one of a convolutional neural network or an object detector.
